(19) United States
(12) Patent Application Publication
(10) Pub. No.: US 2020/0208597 A1
(43) Pub. Date: Jul. 2, 2020

(54) PUMP UNIT FOR FEEDING FUEL TO AN INTERNAL COMBUSTION ENGINE

(71) Applicant: Robert Bosch GmbH, Stuttgart (DE)

(72) Inventor: Ottavio Corizzo, Rolla Imperiale (CS) (IT)

(21) Appl. No.: 16/622,034

(22) PCT Filed: Jun. 11, 2018
(86) PCT No.: PCT/EP2018/065273

§ 371 Date: Dec. 12, 2019

(30) Foreign Application Priority Data
Jun. 13, 2017 (IT) 102017000065571

(51) Int. Cl. F02M 59/46; F02M 59/02; F04B 7/00

(52) U.S. Cl. CPC F02M 59/464; F02M 59/027; F02M 2200/8076; F02M 2200/16; F02M 2200/9053; F04B 7/0057

(57) ABSTRACT

A pump unit for feeding fuel, preferably diesel fuel, to an internal combustion engine, the pump unit comprising: a head (2) inside which a cylinder (3) is formed along an axis (A) for housing a sliding pumping piston (4); an intake valve (8) positioned inside an intake hole (7) between an intake chamber (9) and a compression chamber (10) upstream and downstream of the intake hole, respectively; a plug (11) sealingly connected to the head (2) so as to close the intake chamber; wherein the sealed connection is formed by means of forced surface-to-surface engagement between a portion of an inner surface of an annular wall of the head and a portion of an outer surface of an annular wall of the plug.

### BACKGROUND OF THE INVENTION

The present invention relates to a pump unit for feeding fuel, preferably diesel fuel, to an internal combustion engine.

As is known, a pump unit for feeding fuel, preferably diesel fuel, to an internal combustion engine comprises a head inside which at least one cylinder for housing the associated sliding pumping piston is formed. One end of the pumping piston, in particular the inner end relative to the pump unit, is connected to an actuator, usually a cam shaft which actuates the movement of the piston. A suitable spring is provided for keeping the shaft pressed against the corresponding actuator. With a reciprocating movement along the cylinder, the piston performs an intake stroke, during which fuel is drawn inside the cylinder, and a compression stroke, during which the fuel trapped inside the cylinder is compressed. The portion of the cylinder where compression is performed is called the compression chamber. Generally, feeding into the cylinder is performed through a hole, or intake hole, which is axial relative to the cylinder itself, while discharging of the compressed fuel is performed along a transverse hole, or delivery hole. The external part of the head for receiving the fuel which must be fed to the cylinder is called the intake chamber which is closed externally by a special plug sealingly fastened to the head. Suitable valves are present arranged along the feed and delivery holes for regulating the correct flow of the fuel. Outside the head, the delivery valve is connected to the engine, preferably by means of a common header provided with a plurality of injectors.

The intake chamber, which is connected to the cylinder by means of the intake valve, communicates with an intake duct for feeding the fuel drawn from the storage tank by means of a low-pressure pump, usually a gear pump. The pump unit also comprises filtering systems, for example ring filters at the inlet of the intake chamber, for protecting the components of the high-pressure pump from the impurities present in the fuel fed by the low-pressure pump.

The plug for closing the intake chamber is axially locked against a shoulder of the head by a locking ring nut screwed onto an annular wall projecting from the said head.

As is known, it is necessary to provide a sealed connection between the plug and the head since the pressure inside the intake chamber reaches values equal to a few tens of bars.

At present, in order to provide this sealed connection, it is known to use elastic sealing rings arranged between the plug and the head. In such an embodiment, the surface-to-surface connection between the metal of the plug and the metal of head does not perform any sealing function.

This known solution has a number of drawbacks. In fact, the sealing solution realized with elastic rings is both costly and requires long design and production times to obtain a suitable elastic ring. Moreover, during the assembly stages, local displacement of the elastic ring from the associated seat may occur with negative consequences in terms of the efficiency of the seal.

### SUMMARY OF THE INVENTION

Based on this prior art, an object of the present invention is to provide an alternative pump unit for feeding fuel, preferably diesel fuel, to an internal combustion engine, which does not have the drawbacks described above and is simple and inexpensive to produce.

According to the present invention a pump unit for feeding fuel, preferably diesel fuel, to an internal combustion engine is provided, wherein the pump unit comprises:
a head inside which a cylinder is formed along an axis A for housing a sliding pumping piston;
an intake valve positioned inside an intake hole between an intake chamber and a compression chamber upstream and downstream of the intake hole, respectively;
a plug sealingly connected to the head for closing the intake chamber.

In particular, according to the present invention, the sealed connection is formed by means of surface-to-surface engagement between a portion of the inner surface of an annular wall of the head and a portion of the outer surface of an annular wall of the plug. Preferably, this connection may be provided in two different configurations. According to the first configuration the inner surface of the annular wall of the head has a portion with a conical form engaged with a portion having a curved form of the outer surface of the annular wall of the plug. In this way, by performing tightening for example by means of a ring nut on the outside of the plug, the curved portion of the plug presses against the conical portion of the head in at least one theoretical contact point.

According to the second preferred configuration a kind of geometric inversion is performed, whereby the inner surface of the annular wall of the head comprises a portion with a curved form engaged with a conical portion of the outer surface of the annular wall of the plug. In this case also, by performing tightening for example by means of a ring nut on the outside of the plug, the curved portion of the head presses against the conical portion of the plug in at least one theoretical contact point.

In both the embodiments described above, the connection between the conical surface and the curved counter-surface is configured so as to produce only one theoretical contact point where all the opposing force is discharged, providing a seal suitable for the pressures inside the intake chamber, usually equal to a few tens of bars.

Of the two aforementioned embodiments the first embodiment is the most advantageous in view of the greater ease of forming the curved portion on the plug rather than on the head.

Preferably, the conical and curved contact surfaces are configured so that upstream and/or downstream of the theoretical contact point the plug does not press against the head. Advantageously, along these sections precise surface-machining intended for sealing functions is therefore not required.

According to two alternative variants, the theoretical contact point is located substantially halfway along the extension of the second conical portion of the head or in the vicinity of the outer end of the second conical portion. The embodiment in which the contact point is situated halfway along the extension of the second conical portion of the head is more advantageous because it allows correction of any errors in alignment between plug and head.

According to two alternative variants, the second curved portion is shaped as a circumferential arc or ogive or dome.

Preferably, the plug is made with a steel which is softer than the steel used for manufacture of the head. Advantageously, in this way, as a result of tightening of the plug, the theoretical contact point is developed in a contact zone, increasing the sealing surface area.

### BRIEF DESCRIPTION OF THE DRAWINGS

Further characteristic features and advantages of the present invention will become clear from the description below of a non-limiting example of embodiment thereof, with reference to the figures of the attached drawings, in which:

FIG. 1 is a schematic cross-sectional view, with parts removed for greater clarity, of an embodiment of the pump unit according to the present invention;

FIG. 2 is a view, on larger scale, of the detail of FIG. 1 indicated by II;

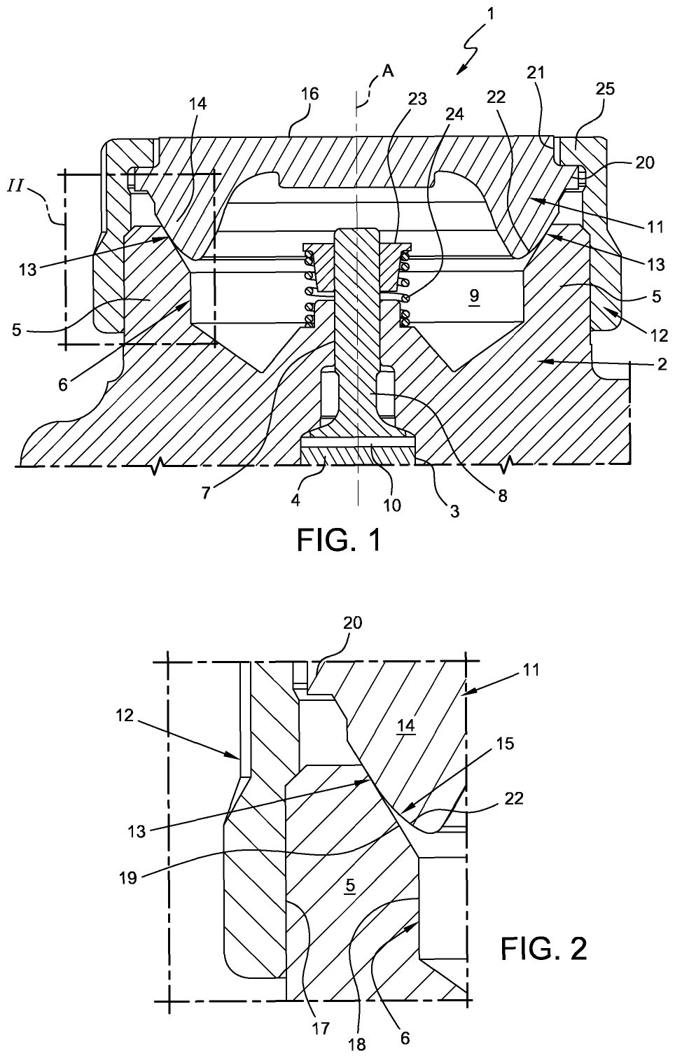

With reference to FIG. 1, the reference numeral 1 denotes in its entirety, a pump unit for feeding fuel, preferably diesel fuel, to an internal combustion engine (not shown).

### DETAILED DESCRIPTION

The pump unit 1 as a whole (which includes also parts not shown) comprises a high-pressure pump with pumping pistons designed to feed the fuel to the said internal combustion engine (not shown); and a pre-feed pump, for example a gear pump, known and not shown, designed to feed the fuel to the high-pressure pump. The high-pressure pump and the gear pump are moved by a shaft (not shown in the attached figures).

The pump 1 therefore comprises a head 2 inside which at least one cylinder 3 extending along an axis A is formed. A pumping piston 4 which extends along the axis A and is slidably engaged with the cylinder 3 is housed inside the cylinder 3.

The incoming flow of fuel into the cylinder 3 is regulated by an intake valve 8 housed inside an intake hole 7 formed on the same axis A of the cylinder. Upstream of the intake valve 7 there is an intake chamber 9 fed with fuel via an intake duct (not shown) also formed at least partly in the head 2. Downstream of the intake valve 7 there is the compression chamber 10, namely the part of the cylinder where compression of the fuel is performed. This compression chamber 10 is in turn connected to a delivery duct formed partly inside the head 2, for feeding the high-pressure fuel to the engine.

The pumping piston 4 is displaced by an actuating device (not shown in the attached figures) along the cylinder 3 with a reciprocating rectilinear movement comprising an intake stroke for drawing the fuel into the cylinder 3 and a compression stroke for compressing the fuel contained inside the said cylinder 3 so as to compress the fuel drawn into the compression chamber 10 from the intake chamber.

The intake valve 8 shown is of the mechanical type and is realized in the form of a movable stem-like closing member which extends along the axis A. This movable closing member 8 cooperates with a spring 24 arranged between the outer surface of the head and a disk 23 fixed integrally to the closing member 8 inside the intake chamber 9.

The intake chamber 9 is closed by a plug 11 sealingly connected to the head 2 and arranged on the opposite side to the pumping piston 4 relative to the intake hole 7. The plug 11 cooperates with a ring nut 12 for clamping the said plug 11 against the head 2. The ring nut 12 engages by means of a thread along an outer surface 17 of an annular wall 5 projecting from the head 2. In particular, the wall 5 further comprises an inner surface 6 along which a sealed connection 13 with a corresponding outer surface 15 of an annular wall 14 of the plug 11 is formed. The annular wall 14 has an extension substantially parallel to the axis A and extends from a top wall 16 of the plug 11 substantially perpendicular to the axis A. Along the annular wall 14, in particular close to the top wall 16, the plug 11 comprises an outer radial collar 20 against which a flange 25 of the ring nut 12 axially bears.

As can be seen in FIG. 1, the seal 13 between the annular wall 14 of the plug 11 and the annular wall 5 of the head 2 does not involve the presence of elastic rings and is realized only by means of surface-to-surface engagement between the inner surface 6 of the annular wall 5 of the head 2 and the outer surface 15 of the annular wall 14 of the plug 11.

FIG. 2 shows an enlarged view of the detail indicated by the reference symbol II in FIG. 1, i.e. shows an enlarged view of the sealing zone 13 between the annular wall 1 of the plug 11 and the annular wall 5 of the head 2.

According to the example of embodiment of FIG. 2, the annular wall 5 of the head 2 comprises a first portion 18 substantially parallel to the axis A and joined to the base of the head 2. In series with this first portion 18, the annular wall 5 of the head 2 comprises a conical portion 19 inclined outwards relative to the axis A so as to widen the intake chamber 9. The annular wall 14 of the plug 11 in turn comprises a first portion 21 substantially parallel to the axis A and joined to the top wall 16 of the plug 11 and a second curved portion 22. In other words, the inclined portion 19 of the annular wall 5 of the head 2 and the second curved portion 22 of the annular wall 14 of the plug 11 form a kind of wedge-like connection, in which the plug 11, pressing axially against the head 2, generates a reaction in the direction perpendicular to the axis A against the conical portion 19 of the wall 5 of the head 2. However, in this aforementioned wedge-like connection the contact wall of the plug 11 is not conical, like a proper wedge, but is curved so as to provide theoretically only one point of contact between the two surfaces.

In the example shown in FIG. 2, the curved portion 22 of the annular wall 14 of the plug 11 is shaped as an ogive. As can be seen, the collar 20 separates the first portion 21 from the second portion 22 of the outer surface 15 of the annular wall 14 of the plug 11.

Since the forced contact between the conical portion 19 of the inner surface 6 of the annular wall 5 of the head 2 and the second ogive-shaped portion 22 of the outer surface 15 of the annular wall 14 of the plug 11 occurs theoretically at one point, at this point 13 an opposing force is created such as to ensure an optimum seal.

Depending on the choice of materials which form the head 2 and the plug 11, the theoretical point of contact 13 may extend over a contact area as a result of the possible greater yielding of one material with respect to the other material. In the example shown, the plug 11 is made of a steel which is softer than the steel used to make the head 2. In this way, under the action of the force generated by tightening of the ring nut 12, the curved surface 22 of the plug 11 may be deformed locally around the theoretical sealing point 13, forming a contact zone which further increases the sealing action.

Finally it is clear that the invention described here may be subject to modifications and variations without departing from the scope of the accompanying claims.

1. A pump unit for feeding fuel to an internal combustion engine, the pump unit (1) comprising:
a head (2) inside which a cylinder (3) is formed along an axis (A) for housing a sliding pumping piston (4);
an intake valve (8) positioned inside an intake hole (7) between an intake chamber (9) and a compression chamber (10) upstream and downstream of the intake hole (7), respectively; and
a plug (11) pressed against the head (2) for sealingly closing the intake chamber (9);
wherein a sealed connection (13) between the plug and the head is formed by forced surface-to-surface engagement between a portion of an inner surface (6) of an annular wall (5) of the head (2) and a portion of an outer surface (15) of an annular wall (14) of the plug (11).

2. The pump unit as claimed in claim 1, wherein the inner surface (6) of the annular wall (5) of the head (2) comprises a curved portion, the outer surface (15) of the annular wall (14) of the plug (11) comprising a conical portion, the conical portion of the plug (11) pressing against the curved portion of the head (2) in at least one theoretical contact point.

3. The pump unit as claimed in claim 1, wherein the inner surface (6) of the annular wall (5) of the head (2) comprises a conical portion (19), the outer surface (15) of the annular wall (14) of the plug (11) comprising a curved portion (22), the curved portion of the plug (11) pressing against the conical portion (19) of the head (2) in at least one theoretical contact point (13).

4. The pump unit as claimed in claim 3, wherein upstream and/or downstream of the theoretical contact point (13) the plug (11) does not press against the head (2).

5. The pump unit as claimed in claim 3, wherein the theoretical contact point (13) is substantially halfway along an extension of the conical portion (19).

6. The pump unit as claimed in claim 3, wherein the theoretical contact point (13) is substantially at an outer end of the conical portion (19).

7. The pump unit as claimed in claim 3, wherein the curved portion (22) is shaped as a circumferential arc.

8. The pump unit as claimed in claim 3, wherein the curved portion (22) is shaped as an ogive.

9. The pump unit as claimed in claim 1, wherein the plug (11) and the head (2) are respectively made of different materials.

10. The pump unit as claimed in claim 9, wherein the plug (11) is made with a steel softer than a steel used for manufacture of the head (2).

11. The pump unit as claimed in claim 3, wherein upstream of the theoretical contact point (13) the plug (11) does not press against the head (2).

12. The pump unit as claimed in claim 3, wherein downstream of the theoretical contact point (13) the plug (11) does not press against the head (2).

13. The pump unit as claimed in claim 12, wherein upstream of the theoretical contact point (13) the plug (11) does not press against the head (2).
